(19) United States
(12) Patent Application Publication
(10) Pub. No.: US 2007/0082710 A1
(43) Pub. Date: Apr. 12, 2007

(54) Method and apparatus for batch-processing of commands through pattern recognition of panel input in a mobile communication terminal

(75) Inventor: Ki-Tae Jang, Seongnam-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/544,150

(22) Filed: Oct. 6, 2006

(30) Foreign Application Priority Data
Oct. 6, 2005 (KR) 2005-0093809

(51) Int. Cl. H04B 1/38; H04M 1/00

(52) U.S. Cl. 455/566; 455/553.1

(57) ABSTRACT

A method and apparatus for batch-processing of commands through recognition of a panel input pattern in a mobile communication terminal is disclosed. The method includes defining a gesture mapping at least one existing pattern to a command. Upon detecting a pattern input, analyzing the pattern and determining whether the pattern already exists. If it is determined that the pattern already exists, a command corresponding to the pattern is processed in a batch.

This application claims priority under 35 U.S.C. § 119 to an application entitled “Method for Batch-Processing of Commands through Pattern Recognition of Panel Input in a Mobile Communication Terminal” filed in the Korean Intellectual Property Office on Oct. 6, 2005 and assigned Serial No. 2005-93809, the contents of which are incorporated herein by reference.

### BACKGROUND OF THE INVENTION

1. Field of the Invention

The present invention relates generally to a mobile communication terminal, and in particular, to a method and apparatus for batch-processing of commands through pattern recognition of panel input.

2. Description of the Related Art

Due to the widespread use of mobile communication terminals attributed to its portability, service providers or terminal manufacturers have been competing to develop more convenient, special features to attract more users. For example, a mobile communication terminal is equipped with the functions of phonebook, games, scheduler, Short Message Service (SMS), Internet, e-mail, morning or wake-up call, MPEG Layer 3 (MP3), digital camera, and electronic dictionary.

As the functions of the mobile communication terminals have become more sophisticated, there is a need for mobile communication terminals having larger display screens and interfaces which function similarly to those of Personal Computers (PCs), such as touch-screen Graphic User Interface (GUI) enabled displays whose usefulness is well established.

For instance, a mobile terminal with a relatively large screen, such as a Personal Digital Assistant (PDA), provides a novel user interface, i.e., a touch panel as an input device, instead of a typical keypad. The touch panel generates a voltage or current signal at a position touched with a stylus pen or a finger that is then used by the controller to thereby input a user's command. Additionally, touch-screen displays may be used to enter graphics and notes that are entered by the user.

The touch panel can be implemented with pattern recognition technology and character recognition technology that are supported by pattern-recognition software. Due to the advantage of convenient entry of user-desired information by a handy tool like a stylus or the like (e.g., a pen or user's finger), that is, the feature of object-oriented information entry, and the resulting use convenience, the touch panel is increasingly used.

However, since conventional touch panels simply function as a keypad by analyzing an input pattern and recognizing a character or symbol, they have not been widely utilized. For example, the touch panel may be configured such that frequently used different functions are combined and mapped to one character or symbol, and thus upon input of the character or symbol through the touch panel, the different functions are invoked in a batch. In this way, user convenience of the mobile communication terminal can be maximized.

### SUMMARY OF THE INVENTION

An object of the present invention is to substantially solve at least the above problems and/or disadvantages and to provide at least the advantages below. Accordingly, an object of the present invention is to provide a method and apparatus of recognizing an input pattern on a touch panel (e.g., a touch pad and/or touch screen) and triggering a reserved function set in a batch according to the recognized pattern.

The above object is achieved by providing a method and apparatus for batch-processing of commands through recognition of a panel input pattern in a mobile communication terminal.

According to one aspect of the present invention, in a method for batch-processing of commands through recognition of a panel input pattern in a mobile communication terminal, a gesture is defined by mapping at least one existing pattern to a command. Upon detection of a pattern input, the pattern is analyzed and it is determined whether the pattern already exists. If the pattern already exists, a command corresponding to the pattern is processed in a batch.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication terminal according to the present invention;

FIG. 2 is a flowchart illustrating an operation for defining a command for a particular action in the mobile communication terminal according to the present invention;

FIG. 3 is a flowchart illustrating an operation for defining an input pattern on a touch panel in the mobile communication terminal according to the present invention; and

FIG. 4 is a flowchart illustrating an overall operation for processing commands in a batch through recognition of an input pattern on the touch panel in the mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

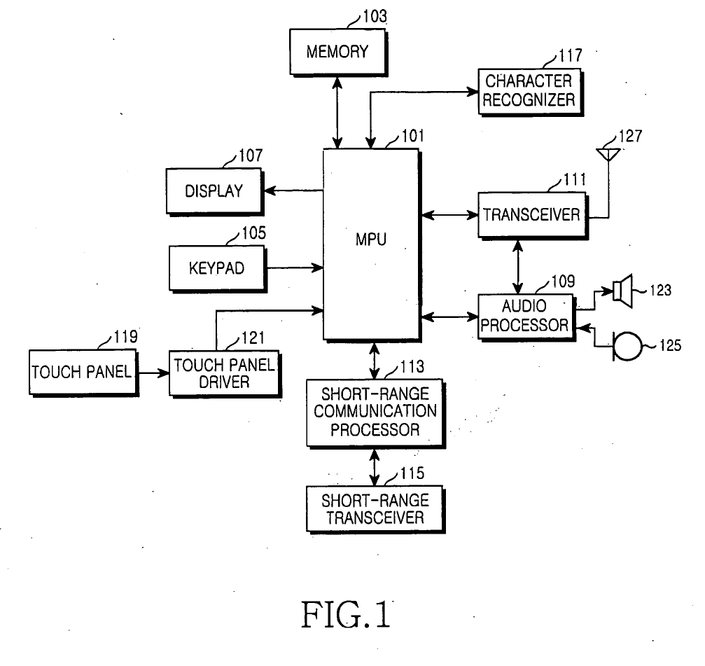

FIG. 1 is a block diagram of a mobile communication terminal according to the present invention.

Referring to FIG. 1, a Micro-Processor Unit (MPU), acting as a controller, 101 provides overall control to the mobile communication terminal. For example, the MPU 101 processes and controls for voice and/or data communications. In addition to typical functions performed by the MPU 101, the MPU 101 performs a function for batch processing of a reserved function set by recognizing an input pattern on a touch panel (e.g., a touch pad and/or touch screen) according to the present invention. For the sake of clarity, a description of typical processing and control operations of the MPU 101 is not provided herein.

A memory 103 may include a Read Only Memory (ROM—not shown), a Random Access Memory (RAM—not shown), a flash ROM, etc. The ROM may store program microcode used for processing and control of the MPU 101, and/or reference data. Particularly, the ROM may store a program for recognizing an input pattern on the touch panel and processing a reserved function set in a batch correspondingly according to the present invention. The RAM may serve as a working memory for the MPU 100 and for temporarily storing data generated during execution of each program. The flash ROM may store updatable data to be kept, such as text material. According to the present invention, the flash ROM preserves a code book and/or a dictionary and stores and manages characters or symbols recognized by a character recognizer 117 in codes in the code book and/or dictionary. Also, the flash ROM may combine codewords in the code book and store and/or manage the resulting code sentences. The flash ROM is provided with an action list, for defining a terminal action, for example, a key input or an event and storing and managing the terminal action as a command. The flash ROM stores a gesture corresponding to a pair of code (or code sequence) and command (or command set) to thereby map the code (or code sequence) to the command (or command set) corresponding to the code.

A keypad 105 is provided with alphanumerical keys, and/or function keys including keys such as Menu, Cancel (Clear), Talk, End, OK, Internet, and navigation (or directional) keys (▴/▾/ [symbol] / [symbol] ). The keypad 105 provides key input data corresponding to a user-pressed key (or keys) to the MPU 101. A display 107 displays status information created during the operation of the mobile communication terminal, a limited number of characters, moving pictures, and still images. The display 107 may include a Liquid Crystal Display (LCD) and/or a color LCD, etc.

An audio processor 109 may be connected to the MPU 101, a speaker 123, and a microphone 125. The audio processor 109, the speaker and the microphone collectively form a voice input/output block for voice calling and/or recording. The audio processor 109 converts digital data received from the MPU 101 to an analog voice signal and outputs the analog voice signal through the speaker 123. Also, the audio processor 109 converts a voice signal received through the microphone 125 to digital data and provides the digital data to the MPU 101.

A transceiver 111 transmits/receives a radio signal through an antenna 127. For transmission, the transceiver 111 processes (i.e., upconverts) transmission data to a Radio Frequency (RF) signal after channel coding and spreading. For reception, the transceiver 111 recovers data by processing a received RF signal through dispreading and channel decoding.

A short-range communication processor 113 may be used to interface a short-range transceiver 115 to the MPU 101. The short-range communication processor 113 can encode signals received from the MPU 101 and provide the coded signals to the short-range transceiver 115. Additionally, the short-range communication processor 113 may decode signals received from the short-range transceiver 115 and provide the decoded signals to the MPU 101.

The short-range transceiver 115 may transmit signals received from the short-range communication processor 113 using a short-range communication scheme such as a Universal Serial Bus (USB), Bluetooth, Infrared Data Association (IrDA), Universal Asynchronous Receiver/Transmitter (UART), and/or Ultra Wide Band (UWB), and provide signals received using the short-range communication scheme to the short-range communication processor 113. In the case of IrDA, a transmitter may use an infrared Light Emitting Diode (LED), and a receiver may use an IrDA photo diode for transmission/reception of data, respectively.

A touch panel 119 outputs touch panel data for the input of a character(s) and/or a symbol(s) entered by a user. The touch panel data may include spatial coordinate data and stroke data indicating the number of strokes for the character or symbol, which are required for recognition of the character or symbol. The touch panel data is processed in the character recognizer 117.

A touch panel driver 121 can include an Analog-to-Digital Converter (ADC—not shown) and can convert an analog signal received from the touch panel 119 to corresponding digital touch panel data. The MPU 101 transfers the touch panel data received from the touch panel driver 121 to the character recognizer 117.

The character recognizer 117 “reads” the touch panel data by calculating coordinate data and/or stroke data, corresponding to one or more of the input character and/or symbol patterns entered by the user through the touch panel 119, using a predetermined program-coded character recognition program, and recognizes the touch panel data as an input character and/or symbol according to the coordinate data and stroke data. The recognized character(s) and/or symbol(s) can be stored as a code (or code sequence) including, but not limited to, ASCII in the memory 103.

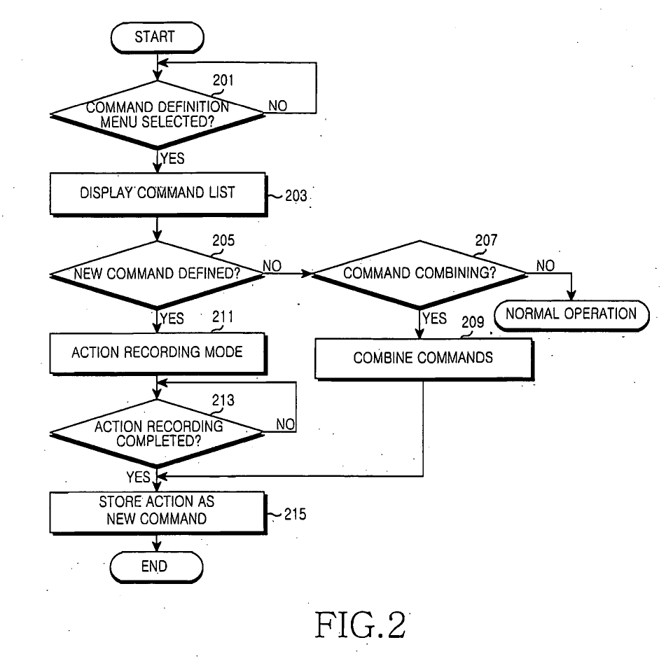

FIG. 2 is a flowchart illustrating an operation for defining a command according to a particular action that a user makes in the mobile communication terminal according to the present invention.

Referring to FIG. 2, the MPU 101 determines whether a command definition menu has been selected by monitoring a key input from the user in step 201. The command definition menu is used to record a particular action(s) such as a key input or an event and define the recorded action(s) as a command. The command definition menu can be selected by entering into the command definition menu or implementing an action recorder for recording a terminal action(s) by pressing a predetermined key. For example, the user may invoke the action recorder by pressing a predetermined soft key for a long period of time. Upon selection of the command definition menu, the MPU 101 outputs an existing command list with particular actions written therein to the display 107 in step 203.

In step 205, the MPU 101 monitors a key input for defining a new command, that is, a key input for recording a new action. If the key input for defining a new command is not detected, the MPU 101 monitors a key input for combining existing commands in step 207. Upon detection of the key input for combining existing commands, the MPU 101 combines user-selected commands from the command list (i.e., the action list) in step 209 and stores the combined command in a new command name set by the user in step 215. If the user does not set a new command name, the MPU 101 stores the combined command in a default name. On the other hand, if the key input for combining existing commands is not detected, the MPU 101 performs a normal operation.

Upon detection of the key input for defining a new command in step 205, the MPU 101 sets the mobile communication terminal to an action recording mode and records an action made by the user in step 211. In other words, every action that the user makes is sequentially stored. An icon indicating the action recording may be displayed in a predetermined area of the display 107.

In step 213, the MPU 101 monitors a key input for terminating the action recording. The action recording is terminated by entering into a user-predetermined menu, or pressing a predetermined key, for example, pressing a predetermined soft key for a long time period. Upon detection of the key input for terminating the action recording, the MPU 101 turns off the icon representing the recording state of the action and records the action(s) in step 215. The recorded action(s) becomes a command and the command is automatically entitled with a default name. Alternatively, the user can assign a name to the command. Then the MPU 101 ends the algorithm of the present invention.

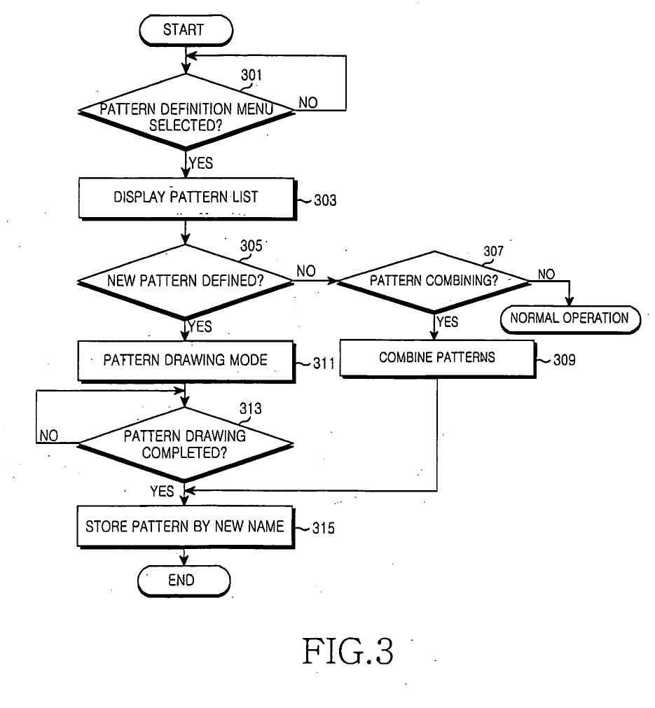

FIG. 3 is a flowchart illustrating an operation for defining an input pattern on a touch panel in the mobile communication terminal according to the present invention. The term “touch panel” may be interchangeably used with touch pad or touch screen.

Referring to FIG. 3, the MPU 101 determines whether the user has selected a pattern definition menu by pressing a predetermined key in step 301. Upon selection of the pattern definition menu, the MPU 101 outputs an existing pattern list to the display 107 in step 303. A pattern(s) listed in the pattern list is stored in a code (or code sequence) in the code book or dictionary of the memory 103.

In step 305, the MPU 101 monitors a key input for defining a new pattern from the user. If the key input for defining a new pattern is not detected, the MPU 101 monitors a key input for combining existing patterns in step 307. Combining existing patterns is a function for processing commands mapped to a plurality of successively drawn patterns. To avoid malfunction caused by inadvertently touching the touch panel, the user defines particular patterns, for example, a start gesture and an end gesture defined as {s} and {e}, respectively, combines a plurality of patterns between the two patterns {s} and {e}, and defines the pattern set by one gesture.

In case of transmission of predetermined text, picture, and files by SMS, Multimedia Messaging Service (MMS), and e-mail, the following can be performed as examples. A pattern set {s} S d k 7 {e} is generated and commands are defined in correspondence with the patterns, so that a text message “Good Luck” is immediately sent to a person listed in the phone book, “Dongsoo Kim”. A pattern set {s} M h 18 {e} is generated and commands are defined in correspondence with the patterns, so that a text, audio, and image file of “Good Luck” are immediately sent to a person listed in the phone book, “Heesoo Lee” by MMS. A pattern set {s} e d k 9{e} is generated and commands are defined in correspondence with the patterns, so that all pictures in a photo album are immediately sent to a person listed in the phone book, “Dongsoo Kim” by e-mail. A pattern set {s} T V 6{e} is generated and commands are defined in correspondence with the patterns, so that an infrared is emitted to select TV channel #6 by IrDA.

Upon detection of the key input for combining existing patterns, the MPU 101 combines user-selected codewords from the pattern list, i.e., the code book in step 309 and stores the combined pattern (code sequence) under a user-set new name in step 315. If the user does not enter a new name, the MPU 101 stores the pattern in a default name. On the other hand, if the key input for combining existing patterns is not detected in step 307, the MPU 101 performs a normal operation.

Upon detection of the key input for defining a new pattern in step 305, the MPU 101 sets the terminal to a pattern drawing mode and receives a pattern from the user through the touch panel 119 in step 311. The MPU 101 recognizes a pattern drawn on the touch panel 119 as a character(s) or symbol(s) and stores the recognized character(s) or symbol(s) as a code (or code sequence) in the code book or dictionary of the memory 103.

In the absence of a touch panel in the terminal, patterns may be input from an accessory equipped with the touch panel function and the short-range communication function. That is, the user draws a pattern on the touch panel of the accessory and the terminal receives the pattern by the short-range communication devices 113 and 115. The short-range communications can be made using a wired connection such as USB and/or wirelessly by using transmission schemes such as Bluetooth, IrDA, UART or UWB.

In step 313, the MPU 101 monitors a key input for ending the pattern drawing. Upon detection of the key input for ending the pattern drawing, the MPU 101 stores the drawn pattern in step 315. The pattern is automatically entitled with a default name or with a user-set name. Then the MPU 101 ends the algorithm of the present invention.

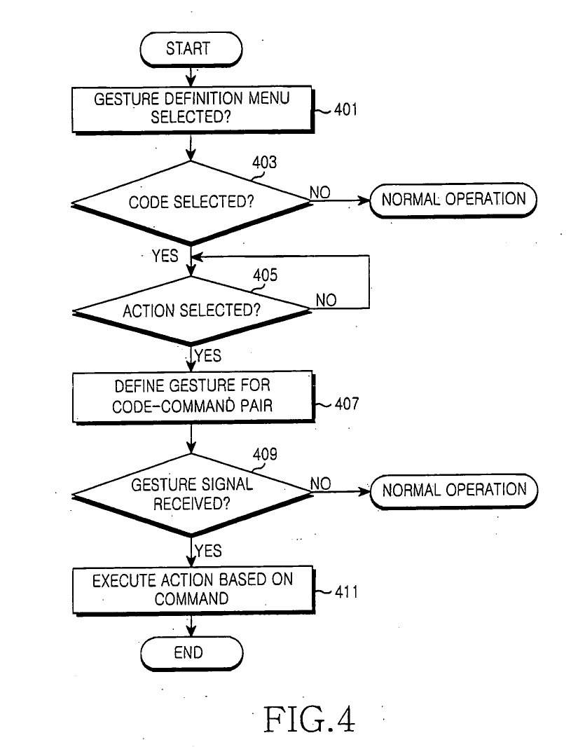

FIG. 4 is a flowchart illustrating an overall operation for processing commands in a batch through recognition of an input pattern on the touch panel in the mobile communication terminal according to the present invention.

Referring to FIG. 4, the MPU 101 triggers a gesture definition menu according to a user's key manipulation in step 401.

The MPU 101 monitors a key input for selecting a code (or code sequence) corresponding to a particular pattern in the code book from the user in step 403. In the absence of the key input for selecting a code (or code sequence), the MPU 101 performs a normal operation.

Upon detection of the key input for selecting a code (or code sequence), the MPU 101 monitors a key input for selecting an action corresponding a particular command in a command list in step 405. The command may be a combination of existing commands. Upon selection of an action, the MPU 101 defines a gesture for the selected pair of code and command in step 407. The MPU 101 stores the gesture in a new name in the memory 103, thus mapping the code to a corresponding pattern. Then the gesture definition menu is terminated.

In step 409, the MPU 101 monitors reception of a gesture signal corresponding to the pattern. In the absence of the gesture signal, the MPU 101 performs a normal operation. Upon receipt of the gesture signal, the MPU 101 automatically executes a command (or command set) mapped to the pattern in a batch in step 411. Specifically, when the user draws a pattern with a stylus pen on the touch panel 119, the MPU 101 recognizes the pattern, i.e. gesture signal as a character or symbol and determines whether the recognized character or symbol exists as a particular code in the code book. In the presence of the character or symbol in the code book, the MPU 101 searches for a gesture corresponding to the pattern in the gesture list and executes the command (or command set) mapped to the pattern.

For an example for batch-processing of commands through pattern recognition of panel input, a series of actions (1) open an MP3, (2) search for “Imagine by John Lennon”, and (3) press keys for play are recorded and entitled with a command “John Lennon”. Then a gesture is created for the command by defining a pattern □. When the user draws the pattern □ on the touch panel 119, the MPU 101 automatically executes the actions in a batch.

In another example, a series of actions to enter into an ordered phonebook search menu [soft 2] key+[5/jkl] key+[6/mno] key+[6/mno] key+[8/ghi] key+[Send] key are defined by a command and then defined by a pattern □, a gesture can be made so that ‘jang’ is searched in the phonebook and then a call is immediately dialed to ‘jang’.

For an emergency, a gesture □ can be created to automatically send SMS and MMS messages to a predetermined number. If a gesture A is defined for invoking voice recording and starting recording and a gesture B is defined for, after the voice recording, automatically sending an e-mail attached with the latest voice file from an e-mail address of the user, the user records voice by the gesture A and sends the voice by the gesture B.

As described above, the present invention processes commands in a batch through pattern recognition of panel input in a mobile communication terminal. Therefore, combining and reserving frequently used functions enables a user to conveniently use the terminal without troublesome key input especially during driving. Furthermore, the present invention offers an ergonomic user interface comparable to natural language processing, substituting for high-cost voice recognition command processing.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for batch-processing of commands through recognition of a panel input pattern in a mobile communication terminal, comprising:
defining a gesture by mapping at least one existing pattern to a command;
analyzing, upon detection of a pattern input, the pattern and determining whether the pattern is an existing pattern; and
processing a command corresponding to the pattern in a batch, if it is determined that the pattern is an existing pattern.

2. The method of claim 1, wherein the pattern is entered by a user using a touch panel including at least one of a touch pad or a touch screen.

3. The method of claim 2, further comprising receiving, via short-range communication, the pattern from an accessory including the touch panel and a short-range communication device.

4. The method of claim 3, wherein the short-range communication is performed using at least one of a Universal Serial Bus (USB), Bluetooth, Infrared Data Association (IrDA), Universal Asynchronous Receiver/Transmitter (UART), and Ultra Wide Band (UWB).

5. A method of defining a command for an action in a mobile communication terminal, comprising:
setting, upon detection of a key input for defining a new command, the mobile communication terminal to an action recording mode and recording an action made by user key-manipulation in the action recording mode; and
storing the action as a predetermined command when the action recording is completed.

6. The method of claim 5, further comprising combining, upon detection of a key input for combining existing commands, user-selected commands and storing the combined commands.

7. A method of defining a pattern drawn on a touch panel in a mobile communication terminal, comprising:
setting, upon detection of a key input for defining a new pattern, the mobile communication terminal to a pattern drawing mode and receiving a pattern; and
storing the pattern, when it is determined that the pattern drawing is completed.

8. The method of claim 7, further comprising combining user-selected patterns and storing the combined patterns, upon detection of a key input for combining existing patterns.

9. The method of claim 7, wherein the pattern is entered by a user using the touch panel including at least one of a touch pad or a touch screen.

10. The method of claim 9, further comprising receiving, via short-range communication, the pattern from an accessory including the touch panel and a short-range communication device.

11. The method of claim 10, wherein the short-range communication is performed using at least one of a Universal Serial Bus (USB), Bluetooth, Infrared Data Association (IrDA), Universal Asynchronous Receiver/Transmitter (UART), and/or Ultra Wide Band (UWB).

12. A mobile communication terminal for batch-processing of commands through recognition of a panel input pattern, comprising:
A memory storing patterns; and
a controller for defining a gesture by mapping at least one existing pattern to a command, analyzing, upon detection of a pattern input, the pattern and determining whether the pattern is an existing pattern, and processing a command corresponding to the pattern in a batch, if it is determined that the pattern is an existing pattern.

13. The mobile communication terminal of claim 12, wherein the pattern is entered by a user using a touch panel including at least one of a touch pad or a touch screen.

14. The mobile communication terminal of claim 13, wherein the controller further performs receiving, via short-range communication, the pattern from an accessory including the touch panel and a short-range communication device.

15. The mobile communication terminal of claim 14, wherein the short-range communication is performed using at least one of a Universal Serial Bus (USB), Bluetooth, Infrared Data Association (IrDA), Universal Asynchronous Receiver/Transmitter (UART), and Ultra Wide Band (UWB).

16. A mobile communication terminal of defining a command for an action in a mobile communication terminal, comprising:
a controller for setting the mobile communication terminal to an action recording mode and recording an action made by user key-manipulation in the action recording mode; and
a memory for storing the action as a predetermined command when the action recording is completed.

17. The mobile communication terminal of claim 16, wherein the controller further performs combining, upon detection of a key input for combining existing commands, user-selected commands and storing the combined commands in the memory.

18. A mobile communication terminal of defining a pattern drawn on a touch panel in a mobile communication terminal, comprising:
a controller for setting the mobile communication terminal to a pattern drawing mode and receiving a pattern; and
a memory for storing the pattern, when it is determined that the pattern drawing is completed.

19. The mobile communication terminal of claim 18, wherein the controller further performs combining user-selected patterns and storing the combined patterns in the memory, upon detection of a key input for combining existing patterns.

20. The mobile communication terminal of claim 18, wherein the pattern is entered by a user using the touch panel including at least one of a touch pad or a touch screen.
